(19) United States
(12) Patent Application Publication
(10) Pub. No.: US 2004/0061729 A1
(43) Pub. Date: Apr. 1, 2004

(54) System and method for a dynamically modifiable driver interface

(76) Inventors: Brett Green, Meridian, ID (US); Kram H. Allen, Meridian, ID (US); Linn J. Kropf, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/262,423

(22) Filed: Sep. 30, 2002

(51) Int. Cl. B41J 29/38

(52) U.S. Cl. 347/5

(57) ABSTRACT

A system is provided for a dynamically modifiable driver interface in an operating system. The system includes a printer driver configured to cooperate with the operating system to facilitate printing. A printer interface is included and configured to display printer related information for the printer driver. A dynamically loadable interface object is associated with the printer interface, and configured to display printer related information and to provide a dynamically modifiable driver interface.

### FIELD OF THE INVENTION

The present invention relates generally to driver interfaces.

### BACKGROUND

When a computer printer manufacturer engineers a printer or electronic printing device, the manufacturer focuses on creating a flexible and powerful piece of hardware that meets consumers' needs. A computer printer or electronic printing device is essentially a piece of hardware and firmware that can print information transmitted to it in the correct format via a computer cable or network connection. In order to receive information for printing, the printer must communicate with an operating system that can send the printer information to print.

The communication between a standalone or networked operating system and a peripheral, such as a printer, occurs via what is known as a software driver or more specifically for a printer, a printer driver. A printer driver is a piece of software that translates information and files received from applications running in the operating system into a format that is usable by the printer.

For example, a file that is sent to the printer driver can be translated into hardware control codes that are interpreted by the printer. These codes can be higher-level PostScript information or detailed machine codes. The control codes include information that directs the various printer commands for formatting text and organizing images.

In addition to interpreting information received from the operating system that can be printed by the printer, the printer driver can control the properties and preferences of the printer. A computer printer has certain physical hardware and/or firmware settings that can be controlled through the printer driver and its associated printer interface. A user is typically able to open a printer interface or printer window located in the operating system interface and access a number of tabs that provide printer properties and/or preferences. For example, the user can usually control features such as the number of pages on a sheet, the dots-per-inch printer output quality, or the size of the paper. In addition, the properties or preferences window can control networking settings such as printer ports and the configuration of the printer spooler. Color management and tray configurations are settings that can be controlled through the printer interface too.

When the printer interface that allows access to attributes, preferences, and properties is created by a printer driver programmer, the interface cannot be changed later unless the programmer rewrites the printer interface and recompiles it. This is because the printer drivers and their accompanying printer interfaces are typically coded in programming languages that are compiled. In addition, the printer interface uses components of the operating system that are generally accessed through a compiled programming language. This means that current printer interfaces and drivers are static and cannot typically be changed without the involvement of the printer driver programmer. In fact, end users and network administrators do not currently have an expectation that the printer interface will be anything but a fixed static interface.

Even when the printer interface has been modified by the programmer, the updated printer interface and driver must be redistributed to those who want the updated printer interface and driver. Once the individuals who want the updated printer interface and driver have received it, the old printer interface and driver can be uninstalled and then the updated printer interface and driver software can be installed. Again, the printer interface and the driver connected to that printer interface is fixed after the printer driver has been compiled. Thus, the printer driver and its associated printer interface do not currently change after it has been installed into the operating system.

### SUMMARY OF THE INVENTION

The invention provides a system for a dynamically modifiable driver interface in an operating system. The system includes a printer driver configured to cooperate with the operating system to facilitate printing. A printer interface is included and configured to display printer related information for the printer driver. A dynamically loadable interface object is associated with the printer interface, and configured to display printer related information and to provide a dynamically modifiable driver interface.

### BRIEF DESCRIPTION OF THE DRAWINGS

FIG. 1 illustrates a printer interface that includes a dynamically loadable interface object or markup language page, scripts and/or activation interfaces in accordance with an embodiment of the present invention;

FIG. 2 illustrates a printer interface as in FIG. 1 where a dynamically loadable interface object or markup language page is loaded and displayed;

FIG. 3 is a block diagram that illustrates local mass storage or an embedded web server where the interface pages, objects or scripts can be stored in accordance with an embodiment of the invention;

FIG. 4 is a block diagram that illustrates an embodiment of a web server or network storage where the interface pages, scripts, and objects can be stored; and

FIG. 5 is a flowchart illustrating operations that can be performed for a dynamically modifiable driver interface in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

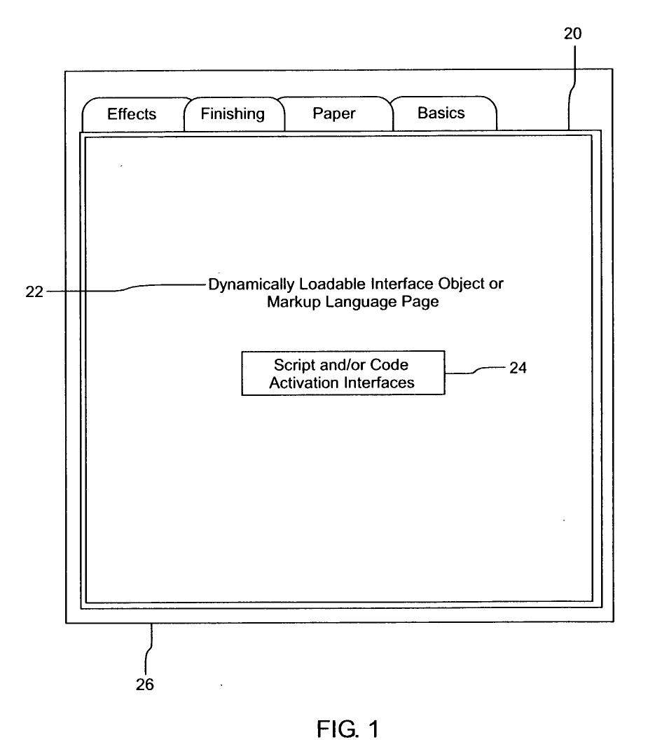

The present invention includes a system and method for a dynamically modifiable driver interface in an operating system. The system includes a printer driver that is configured to cooperate with the operating system to facilitate printing. As illustrated in FIG. 1, the system includes a printer interface 20 that is configured to display printer related information for the printer driver. A dynamically loadable interface object 22 is associated with the printer interface and a window 26 contains the printer interface. The dynamically loadable interface object is configured to display printer related information and to provide a dynamically modifiable driver interface.

The dynamically loadable interface object 22 can be a markup language page or a web page. The markup language pages or web pages are associated with the printer interface and are opened as part of the printer interface when it is displayed in the printer properties and preferences window. The markup language page or web pages can contain script and code activation interfaces 24. The code activation interfaces (e.g., buttons) can trigger CGI scripts, Java code, Java script, or other types of loadable objects that are programmed to perform functions within a web page or dynamically loadable interface object. Another example of a dynamically loadable interface object can be an ActiveX control from Microsoft, a Flash interface from MacroMedia or a similar type of modular control that can be used through a browser.

The dynamically loadable interface objects, web pages, scripts and code, as used in the present invention display the printer properties, preferences, attributes or settings for the specific printer. This allows the end user to modify the printer properties, preferences, attributes, and settings. Moreover, this present system does not require the printer driver programmer to create a fixed interface for the printer driver with a compilable language. Rather, the present system allows the printer driver author to create a markup language page, web page, HTML page or dynamically loadable interface object that can be modified and rearranged by end users or a network administrator.

This system provides a powerful and flexible printer interface in situations where an end user or network administrator would like to be able to change the printer properties and preference controls which are displayed and used in the printer interface. For example, a network administrator may need a different printer interface for a specific group of users for security purposes. Alternatively, customizations may be desired for a specific part of a corporation that has the need for special printer functionality. Using prior methods, a special printer interface would need to be created and distributed by the printer driver programmer, and this is generally not feasible or convenient. In contrast, the present invention allows a network administrator to add or remove controls from a web page as needed.

Not only does this invention avoid the problems of a static interface that cannot be changed, but it also changes the look and feel of the driver interface. Users who access the present printer interface may benefit from the use of the reusable objects that can be similar in appearance and function to interfaces used on a web page. For example, printer driver controls can contain web style controls, such as hyperlinking, web buttons, plug-ins, Java applets, and forms, within the markup language page or dynamically loadable interface object. These web style controls can be used to control and change the printer driver properties, preferences, and attributes.

Using a dynamically modifiable printer interface versus a static printer interface provides other advantages for end users and network administrators. A dynamic driver interface allows the interface to be operating system independent. When operating system changes are made by the operating system supplier, the driver interface may remain the same because it is independent of specific operating system controls and user interfaces.

The driver interface can be modified by editing the markup language page directly which may be in HTML or some other derivative of SGML (Standard Generalized Markup Language). This provides flexibility and ease of upkeep. The web pages or markup language pages can also be modified using style sheets. Style sheets are definitions within web pages that allow users to control the formatting, arrangement and layering of markup language pages. For example, uniform fonts can be used throughout the printer interface or a left-to-right or right-to-left appearance can be setup based on the language being used. The end user or network administrator can change the size or accessibility of the controls that are presented to the user by modifying the web page or style sheet. Scripts or Java objects contained in the page can also be modified by an individual who is somewhat knowledgeable, without recompiling the printer interface.

Since the network administrator is able to control access to functions of a printer for certain end users or groups of end users, this increases the amount of printer driver security and customizability. In some situations, the network administrator may desire to block access to specific properties or preferences that are available for the printer. For example, the network administrator may desire to block specific users from changing the paper size or using color features. Alternatively, the network administrator may desire to enable features that are proprietary to a specific location for printing and copying. The present invention enables these security features.

Individual users may also desire to organize the printer properties or preferences in a specific manner. The present invention allows a user to pick the specific printing options that the user is most interested in and those options can be combined onto a specific web page to be used as a personal tab in the printer window. Alternatively, there may be a group of users, who all want to see the same options for a specific printer. A specific web page or group of objects can be linked to the users' printer interfaces or distributed directly to those users. In contrast, current printer interfaces with compiled code do not allow users to be able to modify, selectively distribute, or otherwise change a printer driver's properties or preferences interface.

Although specific embodiments of this invention have been discussed within the context of computer printers, the invention can also be used with other types of electronic printing devices. Additional types of multi-function printing devices can be used and interfaced with through a dynamically loadable interface object. Examples of multi-function printing devices are combination copier, scanner, printing devices, faxing devices, or similar devices which include printing capabilities.

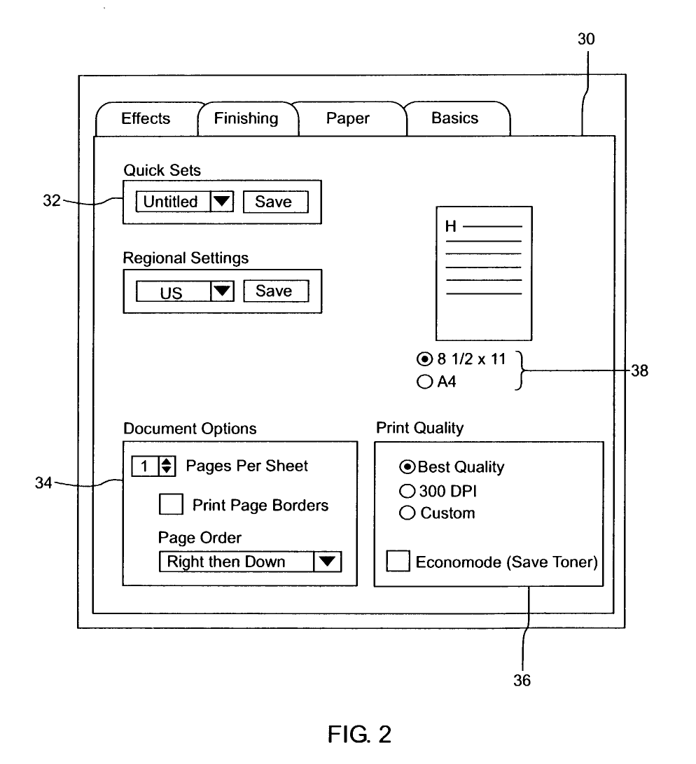

FIG. 2 illustrates examples of printer driver controls that can be contained within a printer interface 30. These printer controls may range from drop-down windows 32 that control macro printer settings to document options 34. The size of the paper 38 can also be controlled. Quality selections 36 or other buttons can be included to activate and control printer driver properties and preferences. Embedded applications or plug-ins can also provide printer use statistics or costs charged to a user or department. Of course, additional printer interface controls can be included or created as known to those skilled in the art.

When a button, drop-down list, or control is activated, these events can activate executable scripts or objects contained within the dynamically loadable interface object or web page. These scripts and objects may be CGI scripts, Java scripts, Java programs, or Visual Basic scripts. These scripts or executable objects allow for detailed properties changes or program activated changes to be made to the printer properties, preferences and settings.

The markup language page or web page is viewed using a browser or mini-browser that is embedded in the printer driver window. Since the embedded browser in combination with the dynamically loadable interface object or markup language page can provide all the same features that are available in Internet web pages, this provides a wide variety of features that have not been available for a printer interface in the past. Use of a web page or markup language object makes it a very straightforward process to dynamically incorporate menus, usage graphs, pictures, tree lists, and other navigation features that are not typically able to be incorporated into a static, precompiled printer interface with printer driver controls.

An embodiment of the present invention allows users or network administrators to add additional web style controls at any point in time. Users can also include corresponding script, or embedded objects with the web style controls that allow for user interface customizations such as a Flash plug-in, video plug-in, or access to a company support site link for additional help with the printer driver. A dynamic interface also permits the printer interface to be modified as specific hardware modifications or firmware updates are made to the printer. These changes can be made without recompiling the printer driver and interface.

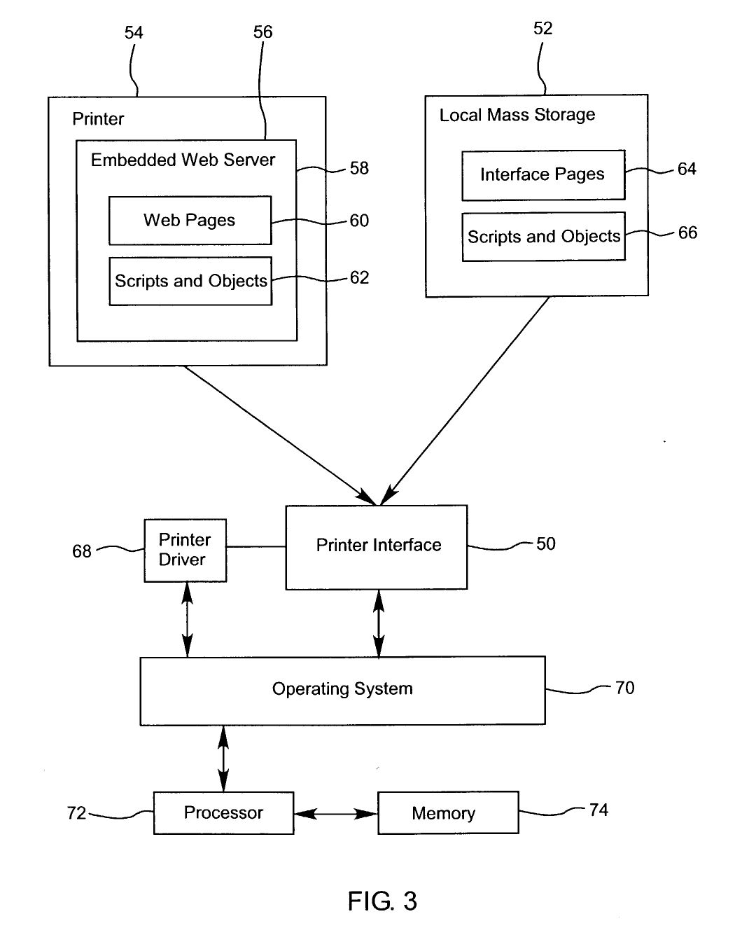

FIG. 3 illustrates two possible locations where the markup language pages, web pages, or dynamically loadable interface objects can be stored. Specifically, the pages, scripts, and objects can be stored on a local mass storage drive 52 such as a hard drive or Flash RAM that is located with a computer where the printer driver 68 is installed. The interface pages 64, executable scripts, and objects 66 are loaded into the printer interface 50 when a user accesses the printer's properties and preferences. When the interface pages are modified, then new interface pages, scripts and objects can be copied over the old ones stored on the mass storage unit. The printer driver and the printer interface will also be running within the environment of an operating system 70 that is running on a processor 72 with an associated memory medium 74.

In another embodiment, the markup language pages or web pages 60 can be stored in an embedded web server 58 that is physically located inside a printer 54 or in a web server electronically linked with the printer. When the web pages, scripts and executable objects 62 are located within an embedded web server associated with the printer, every user loads the pages into their printer interface 50 from the embedded web server at its networked location. This is advantageous because the dynamically modifiable driver interface is stored with the printer itself and the printer interface is stored in only one location. Thus, when users need to access the printer interface, a current source can always be located with the printer itself.

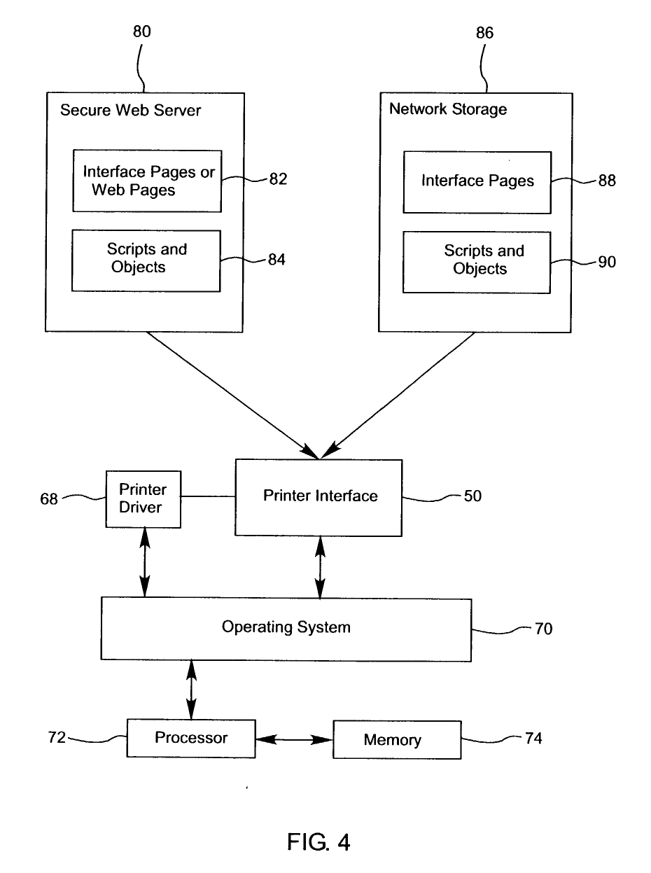

FIG. 4 is a block diagram that illustrates additional networked locations where a modifiable printer interface using a markup language page or web page can be stored. One location where the interface pages 82, scripts and objects 84 can be stored is within a secure web server 80. This allows an end user to retrieve the interface pages or web pages into their printer interface 50 from a secure web server that is located within a Local Area Network (LAN) or even a secure web server that is located on the Internet. This means that a networked printer that is shared between separate entities or multiple divisions of a corporation can all view the same modifiable printer interface for controlling a shared printer's properties and preferences.

The interface pages 88, scripts and objects 90 can also be stored in other network storage locations 86. The network storage can be on either a local area network (LAN) such as a server or network attached storage, or a wide area network (WAN) that is physically remote from the computer accessing the network storage. For example, a user in one building on a campus may need access to a printer's properties even though the printer interface and physical printer are located in a separate building on the company's campus.

The printer interface 50 in this embodiment of the invention can use a web browser or proprietary browser to interpret and display the web pages and dynamically loadable objects that are accessed from the printer interface. The browser can use HTTP, Java, XML and similar well known standards defined for internetworking. The printer interface, driver, and browser can execute within an operating system 70 that is running on at least one processor 72 and a memory module 74.

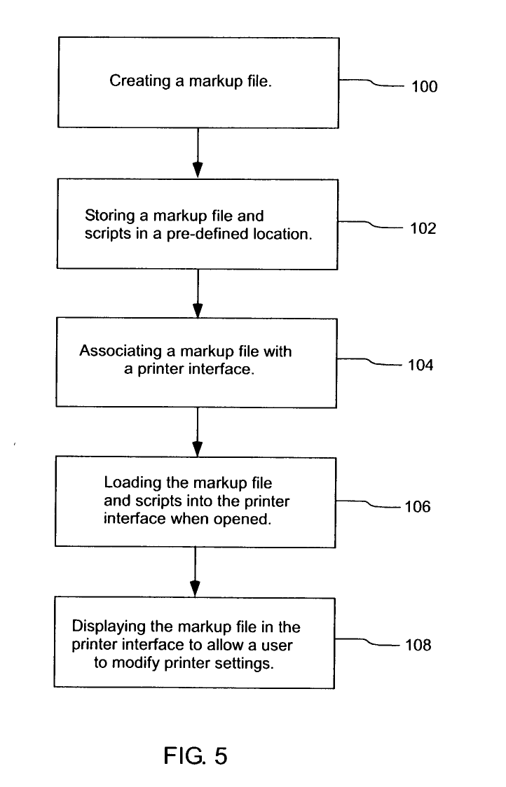

FIG. 5 illustrates a method for dynamically modifying a printer driver interface in a printer interface window that is accessed through an operating system. The method includes the operation of creating a markup file and scripts in block 100. The markup file and scripts can be created by a network administrator, by a printer driver programmer or even by an end user. A further operation is storing a markup file and associated executable objects or scripts in a pre-defined location in block 102. The predefined location may be on a network, in an embedded web server, or on a local computer system. An additional operation is associating the markup file with the printer interface in block 104. Once the markup file has been connected to the printer interface, the printer interface can be opened and the markup file is loaded into the printer interface in block 106. A further operation is displaying the markup file in the printer interface in a window to allow a user to modify the printer settings in block 108. The printer settings can include printer properties and preferences as described above.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A system for a dynamically modifiable driver interface in an operating system, comprising:
a printer driver configured to cooperate with the operating system to facilitate printing;
a printer interface configured to display printer related information for the printer driver; and
a dynamically loadable interface object, associated with the printer interface, configured to display the printer related information and to provide a dynamically modifiable driver interface.

2. A device as in claim 1, wherein the dynamically loadable interface object can modify printer driver related properties, preferences and settings.

3. A device as in claim 1, further comprising printer driver controls contained within the dynamically loadable interface object configured to control the printer driver properties and preferences.

4. A device as in claim 1, wherein the dynamically loadable interface object resides in a storage location that is selected from a group of storage locations consisting of a local hard drive storage location, a local area network and a wide area network storage.

5. A device as in claim 1, further comprising executable scripts that are used with the dynamically loadable interface object to enable printer functions.

6. A device as in claim 1, wherein the printer interface further comprises a browser to interpret and display the dynamically loadable interface object.

7. A device as in claim 1, wherein the dynamically loadable interface object can be created by a network administrator, printer driver programmer or end user.

8. A system for a dynamically modifiable driver interface in an operating system, comprising:
a printer driver configured to receive information from the operating system and send the information to a printer for printing;
a printer interface window configured to display printer related information for the printer driver; and
a markup language page, that is loaded into the printer interface window each time the printer interface window opens, and the markup language page is configured to enable display and modification of the printer related information for the printer driver, whereby the driver interface is dynamically modifiable.

9. A device as in claim 8, further comprising printer driver controls contained within the markup language page to control printer driver properties and preferences.

10. A device as in claim 8, further comprising printer driver controls that are associated with scripts that can be activated to control printer functions.

11. A device as in claim 8, wherein the markup language page further comprises stylesheets to control formatting, arrangement, and layering of the markup language page.

12. A device as in claim 8, wherein the markup language page is stored in a networked location as controlled by a network administrator.

13. A device as in claim 8, wherein the markup language page is stored on a local computer with the printer driver.

14. A device as in claim 8, further comprising executable scripts that are contained within the markup page window that enable printer functions.

15. A device as in claim 8, further comprising executable objects that are contained within the markup language page to modify printer functions.

16. A device as in claim 8, wherein the markup language page is a web page.

17. A device as in claim 16, wherein the web page is a HTML page.

18. A device as in claim 16, wherein the printer interface window further comprises a web browser to interpret and display the web page.

19. A device as in claim 8, wherein the markup language page can modify and update the printer properties and preferences associated with a printer through the printer driver.

20. A method for dynamically modifying a printer interface for a printer driver in an operating system, comprising the steps of:
storing a markup file for use with the printer interface;
associating the markup file with the printer interface;
loading the markup file when the printer interface is opened; and
displaying the markup file in the printer interface to allow a user to modify printer settings.

21. A method as in claim 20, further comprising the step of creating a markup file.

22. A method as in claim 21, further comprising the step of enabling a network administrator, printer driver programmer, or end user to create a markup file.

23. A method in accordance with claim 20, wherein the step of storing a markup file for use with a printer driver interface further comprises the step of storing at least one script that can be accessed in the printer interface.

24. A method as in claim 20, further comprising the step of storing the markup file in a storage location that is selected from a group of storage locations consisting of a local hard drive storage location, a local area network and a wide area network storage.

25. A method as in claim 20, further comprising the step of refreshing the markup file in a printer interface window when the markup file changes.

26. A method as in claim 20, further comprising the step of including an executable object with the markup file.

27. A method as in claim 20, further comprising the step of including at least one Java object with the markup file.

28. A method as in claim 20, further comprising the step of including a script with the markup file.

29. An article of manufacture, comprising:
a computer usable medium having computer readable program code embodied therein for dynamically modifying a printer interface for a printer driver in an operating system, the computer readable program code means in the article of manufacture comprising:
computer readable program code for storing a markup file for use with the printer interface;
computer readable program code for associating the markup file with the printer interface;
computer readable program code for loading the markup file when the printer interface is opened; and
computer readable program code for displaying the markup file in the printer interface to allow a user to modify printer settings.

30. A system for a dynamically modifiable driver interface in an operating system, comprising:
a printer driver means configured for facilitating printing in cooperation with the operating system;
a printer interface means for displaying printer related information for the printer driver; and
a dynamically loadable interface means, associated with the printer interface, for displaying the printer related information and to provide a dynamically modifiable driver interface.

31. A device as in claim 30, further comprising printer driver control means contained within the dynamically loadable interface means for controlling the printer driver properties and preferences.
